(19) United States
(12) Patent Application Publication
(10) Pub. No.: US 2012/0065768 A1
(43) Pub. Date: Mar. 15, 2012

(54) NUMERICAL CONTROLLER AND NUMERICAL CONTROL MACHINING SYSTEM

(75) Inventor: Akihiro Sakata, Chiyoda-ku (JP)

(73) Assignee: MITSUBISHI ELECTRIC CORPORATION, Chiyoda-ku, Tokyo (JP)

(21) Appl. No.: 13/320,869

(22) PCT Filed: Jun. 10, 2009
(86) PCT No.: PCT/JP2009/002603

§ 371 Date: Nov. 16, 2011

(51) Int. Cl. G05D 3/00; G05B 15/00

(52) U.S. Cl. 700/187

(57) ABSTRACT

An NC machining system includes a chuck that clamps a workpiece; a first rotation axis, located opposite the chuck, that rotates as a main axis; a second rotation axis that rotates about its center on the first axis; a numerical control apparatus that outputs, according to on pre-programmed machining instructions, rotation commands for the first and the second rotation axes; and a tool, fixed on the second rotation axis, that moves along a circumference of the workpiece by a rotation of the first rotation axis, and whose machining radius is determined by a rotation of the second rotation axis.

### TECHNICAL FIELD

The present invention relates to numerical controllers (hereinafter “NC apparatuses”) and NC machining systems. The invention is associated with, in particular, an NC apparatus and an NC machining system that controls a machining tool having, on a first rotation axis rotating as a main axis, a second rotation axis that controls a tool, and having a workpiece machining radius (a virtual axis corresponding to a straight line axis called X axis (hereinafter “virtual axis X”) in a conventional lathe-type machining tool).

### BACKGROUND ART

A conventional lathe-type machining tool rotates a workpiece with it fitted on a main axis thereof. The machining tool machines the workpiece by causing a workpiece turning tool to move along a straight line axis in a radial direction of the workpiece and an axis in a longitudinal direction thereof.

Patent Document 1 discloses a method of machining a workpiece by rotating a tool such as a boring tool without rotating the workpiece when the workpiece is machined in a cylindrical or taper shape and by controlling two straight line axes (X and Y axes) orthogonal to the tool to move in an circular arc—that is, a technique that is used to machine the workpiece in a cylindrical shape by moving a tool that rotates with respect to the workpiece (a tool rotating like a drill) in a circular arc with respect to a fixed workpiece.

### [Patent Document 1]

Japanese Unexamined Patent Application Publication No. H8-126938

### DISCLOSURE OF INVENTION

### Problem that the Invention is to Solve

A problem is that the conventional NC apparatus like the foregoing rotates a workpiece by placing the workpiece on its main axis, and if the workpiece is relatively large in diameter and long in length, its weight increases and its mechanical stability is reduced during rotation, thereby requiring that the speed of the main axis be maintained low.

A problem with a machining method disclosed in Patent document 1 is that a time period for machining a workpiece is longer than when a lathe-type machining tool is used, because the operation for machining the workpiece in a cylindrical or taper shape involves movement in a circular arc along two orthogonal straight line axes (X and Y axes).

The invention associated with this NC apparatus is directed to overcome such problems, and an object of the invention is to machine a workpiece by disposing a second axis, which is a tool position controlling axis, on a first rotation axis, which is a rotation axis rotating as a main axis.

### Means for Solving the Problem

An NC machining system according to the present invention includes a chuck that clamps a workpiece; a first rotation axis, located opposite the chuck, that rotates as a main axis; a second rotation axis that rotates about its center on the first axis; a numerical control apparatus that outputs, according to pre-programmed machining instructions, rotation commands for the first rotation and the second axes; and a tool, fixed on the second rotation axis, that moves along a circumference of the workpiece by a rotation of the first rotation axis, and whose machining radius is determined by a rotation of the second rotation axis.

The NC machining system outputs, according to the pre-programmed machining instructions, rotation commands of the first and the second rotation axes so that the tool moves on a virtual axis—a straight line connecting a tool position and the center of a first rotation axis.

The NC machining system outputs, according to the pre-programmed machining instructions, a move command that causes the tool to move in a direction of a straight line connecting the workpiece and the chuck.

An NC apparatus according to the invention outputs a rotation command that instructs a first rotation axis to moves along a circumferential surface of a workpiece; and a rotation command that instructs a second rotation axis to determine a machining radius of a tool, according to pre-programmed machining instructions for the first rotation axis, located opposite a chuck for clamping the workpiece, that rotates as a main axis, and for the second rotation axis on which the tool is fixed and that rotates with its center on the first rotation axis.

The NC apparatus outputs, according to on the pre-programmed machining instructions, rotation commands for the first and the second rotation axes so that the tool moves on a virtual axis that is a straight line connecting a predetermined position of the tool with the center of the first rotation axis.

The NC apparatus outputs, according to the pre-programmed machining instructions, a rotation command that moves the tool in a direction of a straight line connecting the workpiece with the chuck.

The NC apparatus includes a program analysis unit that analytically examines the pre-programmed machining instructions on a block basis, and analyzes an amount of movement of the virtual axis in a single block; an interpolation unit that calculates, based on results of analysis made by the program analysis unit, an amount of movement of the virtual axis, to be produced at intervals of an interpolation period; and a movement assignment unit that converts the amount of movement of the virtual axis calculated by the interpolation unit into an amount of movement of a rotation angle of each of the first and the second rotation axes.

### Advantageous Effects of the Invention

In an apparatus according to the present invention, since a workpiece turning tool is located on a first rotation axis rotating as a main axis, the workpiece itself does not need to be rotated and the workpiece can be machined with stability being maintained. Also in the apparatus according to the invention, a method of clamping the workpiece does not use a machining process in a machining center where a rotation tool is operated in a circular arc, as in Patent Document 1, but uses a lathe-type machining process—turning—where the tool itself rotates; thus, the process of turning allows the workpiece to be circularly processed with stability being maintained and at a high velocity.

### BRIEF DESCRIPTION OF DRAWINGS

FIG. 1 is a diagram illustrating an NC apparatus and a chief part of an NC machining tool to be controlled by the NC apparatus according to Embodiment 1 of the present invention;

FIG. 2 is a conceptual diagram of the first and the second rotation axes as viewed from an axis extension point of the rotation axes, in situations where a cutting tool is located outermost in a machining radius of a workpiece;

FIG. 3 is a conceptual diagram illustrating an operation of a second rotation axis in situations where FdT of the virtual axis X calculated by an interpolation unit is assumed to move a virtual axis X to a position Xb;

FIG. 4 is a conceptual diagram illustrating a situation where a correction operation for the first rotation axis improves a position of the cutting tool relative to the first rotation axis;

FIG. 5 is a conceptual diagram in situations where although the correction operation for the first rotation axis improves the position of the cutting tool relative to the first rotation axis of the cutting tool, the direction of a tool cutting edge is misaligned; and

FIG. 6 is a diagram illustrating a situation where taper-thread cutting is made by a sequence of control operations.

### REFERENCE NUMERALS

NC machining tool: 100, NC apparatus: 50, First drive unit: 1, Second drive unit: 2, Third drive unit: 3, Servo motor: 4, First rotation axis: 5, Second rotation axis: 6, Cutting tool: 7, Ball screw: 8, Headstock: 10, Chuck: 11, Workpiece: 12, Servo signal processing unit: 55, Servo signal processing unit: 50, Program analysis unit: 51, Interpolation unit: 52, Manual command unit: 53, Movement assignment unit: 54, Servo signal processing unit: 55, Pre-programmed machining instructions: 60, Operation panel: 61, Manual pulse generator: 62.

### BEST MODE FOR CARRYING OUT THE INVENTIONS

### Embodiment 1

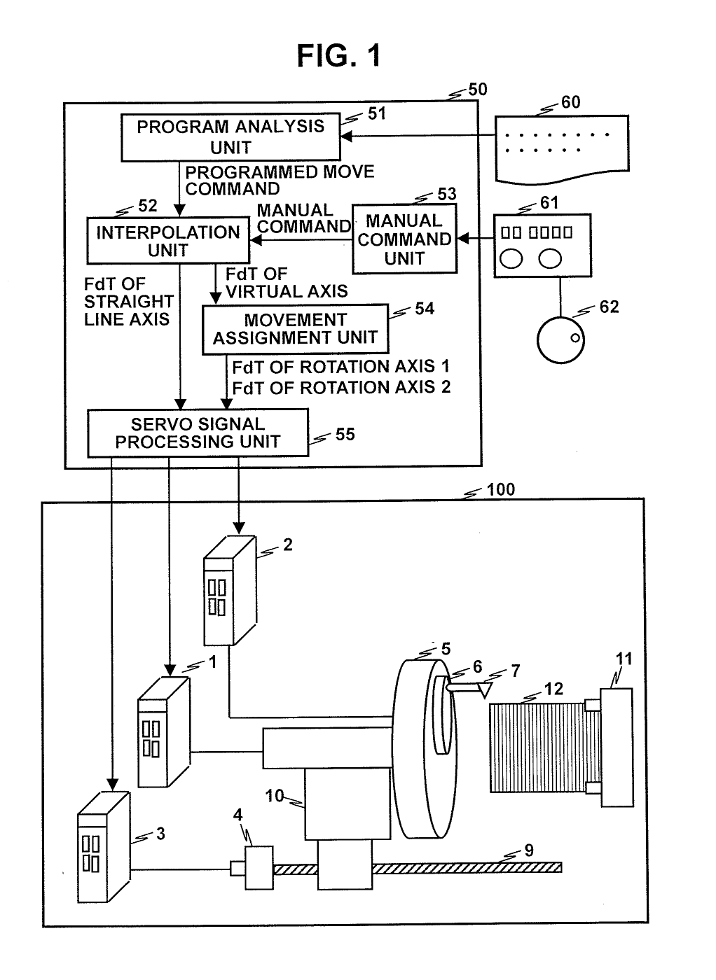

FIG. 1 is a diagram illustrating chief parts of an NC apparatus 50 and an NC machining tool 100 to be controlled by the NC apparatus 50 according to Embodiment 1 of the present invention. In FIG. 1, the NC apparatus 50 controls the NC machining tool 100 that is a target machining tool to be controlled.

The NC machining tool 100 includes a first drive unit 1, a second drive unit 2, a third drive unit 3, a servo motor 4, a first rotation axis 5, a second rotation axis 6, a tool 7, a ball screw 9, a headstock 10, and a chuck 11. A workpiece 12 is clamped by the chuck 11. Based on instructions from a servo signal processing unit 55 as will be described later, the first drive unit 1 causes rotation of the first rotation axis 5 serving as a main axis. The first rotation axis 5 is held on the headstock 10. The second drive unit 2 causes the second rotation axis 6 to rotate on the first rotation axis 5, and the cutting tool 7 (cutting tool) to move in a radial direction of the workpiece 12 (virtual X axis). Also, the third drive unit 3 causes rotation of the servo motor 4, and the servo motor 4, in turn, causes rotation of the ball screw 9, thereby moving the headstock 10 and the first rotation axis 5, located on the headstock, on a straight line connecting the first rotation axis 5 with the chuck 11—in a longitudinal direction of the workpiece 12. A cutting tool will be described as an example of the tool 7; however, a type of the tool 7 is not limited to this one.

On the other hand, the NC apparatus 50 includes a program analysis unit 51, an interpolation unit 52, a manual command unit 53, a movement assignment unit 54, and a servo signal processing unit 55. The program analysis unit 51 analytically examines pre-programmed machining instructions 60 on a block basis, to analyze an amount of movement of each axis in a single block.

The pre-programmed machining instructions 60 refer to dedicated programmed instructions containing commands that cause operation of the NC machining tool 100. For example, G code or m2 code, as defined in JIS B 6315-2, is used in some cases, but the code is not limited to this one. A single block of the pre-programmed machining instructions 60 refers to codes in a single line in the pre-programmed machining instructions. Since the pre-programmed machining instructions 60 are typically interpreted line by line, the unit of this processing is referred to as “block.”

The manual command unit 53 processes a manual move command provided thereto from an operation panel 61 and a manual pulse generator 62. The interpolation unit 52 calculates an amount of movement (hereinafter, “FdT”) to be produced at intervals of an interpolation period on an axis basis, based on results calculated by the program analysis unit 51 and the manual command unit 53. The movement assignment unit 54 assigns a commanded amount of movement for the virtual axis X of the workpiece 12 out of FdTs calculated by the interpolation unit 52, to the amounts of movement of the first and the second rotation axes 5 and 6. The servo signal processing unit 55 transmits FdTs, calculated by the interpolation unit 52 and the movement assignment unit 54, to the first, the second and the third drive units 1, 2 and 3. The operation panel 10 and the manual pulse generator 62 are described as external devices of the NC apparatus 50, but the invention is not limited to such devices. In some cases, the operation panel 10 and the manual pulse generator 62 exist as part of the NC apparatus 50.

Next, automatic and manual mode operations for the NC apparatus will be described separately.

In the auto mode operation, the pre-programmed machining instructions 60 contain a rotation speed command for operating the first rotation axis 5 as the main axis, and a move command for the virtual axis X, as well as move commands for other operation axes (Y and Z axes) that are other than the virtual axis. The program analysis unit 51 reads the pre-programmed machining instructions 60, to analytically examine the read machining instructions 60 on a block basis and calculate a rotation speed of the first rotation axis 5 serving as the main axis and an amount of movement by a single block for each of the axes including the virtual axis X.

In the manual mode operation, the operation panel 61 is incorporated with an operation switch for the virtual axis X, as well as an operation switch for other operation axes. Further, it is incorporated with a switch for allotting manual pulses, generated by the manual pulse generator 62, to the virtual axis X. The manual command unit 53 calculates, as an amount of movement for each of the axes including the virtual axis X, a manual movement command generated by the switch on the operation panel 61 or by the manual pulse generator.

The interpolation unit 52 is activated at fixed intervals (e.g., 1 millisecond) referred to as interpolation period, and calculates, according to a well-known interpolation method, FdT for each of the axes including the virtual axis, using amounts of movement calculated by the program analysis unit 51 in the auto mode operation and by the manual command unit 53 in the manual mode operation.

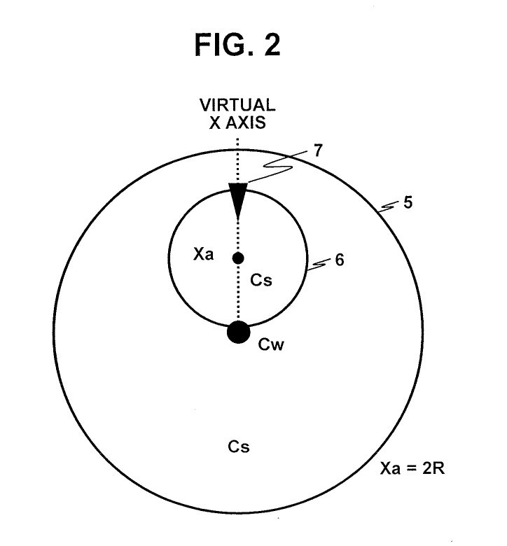

Based on FdT for the virtual axis X out of FdTs calculated for the axes by the interpolation unit 52, the movement assignment unit 14 makes assignment of FdTs of the first and the second rotation axes 5 and 6. A calculation method for the assignment will be described. First, referring to FIG. 2, the method will be described in terms of conversion of a position command for the virtual axis X into a rotation angle of the second rotation axis 6.

FIG. 2 is a conceptual diagram as viewed from the workpiece 12 when the cutting tool 7 is located outermost in a machining radius of the workpiece 12. This state is assumed to represent the positional reference of relationship between the first and the second rotation axes 5 and 6 and the virtual axis X. In this case, the position of the cutting tool 7 on the virtual axis X is given as Xa. A rotation angle (D) of the first rotation axis—an angle formed between the virtual axis X and a straight line connecting the cutting tool 7 with the center (Cw) of the first rotation axis—is treated as zero. Also, a rotation angle (U) of the second rotation axis—an angle formed between the virtual axis X and a straight line connecting the cutting tool 7 with the center (Cs) of the second rotation axis—is treated as zero. The center (Cw) of the first rotation axis in FIGS. 2-4 moves along the circumference of the second rotation axis 6 where the cutting tool 7 is fixedly attached.

Given that the radius of the second rotation axis 6 is R, the position Xa on the virtual axis X of the cutting tool 7 in FIG. 2 is represented by the equation:

Xa=2R cos(0)

=2R.

Typically, the relationship between the rotation angle (U) of the second rotation axis 6 and the virtual axis X is represented by the equation:

U=2 cos⁻¹(X/2R).

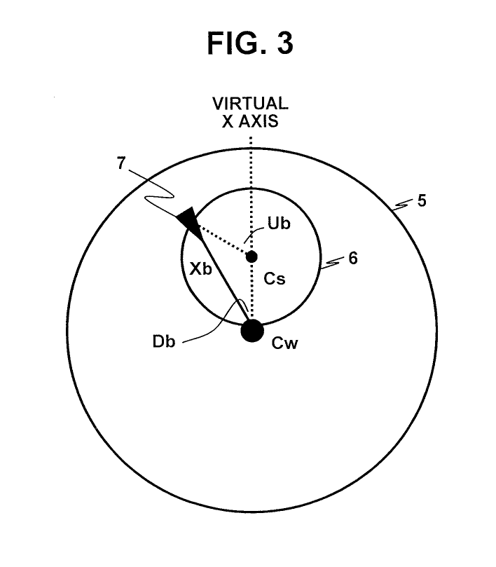

FIG. 3 is a conceptual diagram where the first rotation axis 5 rotates one turn (360 degrees), and the second rotation axis 6 rotates Ub turn relative to the second rotation axis (Cs). At this time, the rotation angle (Ub) of the second rotation axis is represented by the equation:

Ub=2 cos⁻¹(Xb/2R).

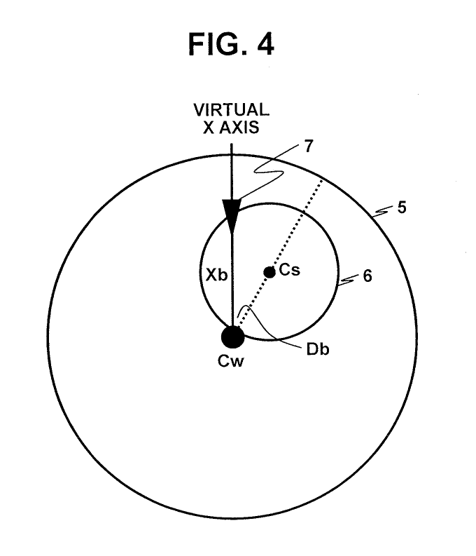

For instance, when thread cutting is effected on a workpiece, a conventional turning process causes the Z axis to move by a thread pitch (a span between thread ridges) during rotation of one turn (360 degrees) of the main axis. In taper-thread cutting (where threads are made whose diameter varies to taper) using the NC machining tool 100, when the first rotation axis 5 rotates one turn (360 degrees) during transition of the state from FIG. 2 to FIG. 3, the rotation angle of the first rotation axis 5 becomes Db as a result of rotation of the second rotation axis 6 relative to the center (Cs) of the second rotation axis 6. In other words, the cutting tool 7 is positioned to slant by Db relative to the virtual axis. Because of this, the cutting tool 7 actually rotates more than one turn (360+Db degrees) about the center (Cw) of the first rotation axis, resulting in inappropriate spans between thread ridges. For this reason, taper-thread cutting is needed where the position of the cutting tool 7 is corrected to that shown in FIG. 4 and the cutting tool 7 is thereby rotated 360 degrees. In other words, referring to FIG. 3, the cutting tool 7 needs to move on the virtual axis X so that the rotation angle (Ub) of the second rotation axis becomes zero degree.

Next, calculation of an amount of correction will be described where the amount is additionally provided to the first rotation axis 5 so that the cutting tool 7 moves rectilinearly on the virtual axis. Because the cutting tool 7 moves with the rotation of the second rotation axis 6, when as shown in FIG. 3, the cutting tool 7 is at a distance Xb away from the center (Cw) of the first rotation axis, the rotation angle of the first rotation axis becomes Db. Namely, the cutting tool 7 moved to a position slanted Db from the positional reference on the first rotation axis 5. Here, the slant Db is represented by the equation:

Db=Ub/2.

In particular, when the workpiece 12 is drilled inwardly from its surface toward its center with a hole-boring drill attached to the cutting tool 7, the tool 7 needs to be prevented from moving to its slanted position as shown in FIG. 3. FIG. 4 is a conceptual diagram in situations where correction operation for the first rotation axis 5 improves a position of the cutting tool 7 relative to the first rotation axis—namely, where the rotation angle of the second rotation axis 6 is seemingly zero degree. In the second rotation axis 6, in synchronization with the angle of the second rotation axis being set to Ub—specifically, with the cutting tool 7 moving to the position Ub—the position of the cutting tool 7 is corrected by moving the cutting tool 7 to a position of 360 degree minus Db with reference to the first rotation axis 5, as shown in FIG. 4.

In other words, a state where the cutting tool 7 moves to its slanted position is shown in FIG. 3, and the tool position is slanted when compared to that in FIG. 2. A state where this slanted position is corrected to an unslanted position in comparison to that in FIG. 2, is shown in FIG. 4. When, with no corrective action being taken, the state of FIG. 2 transfers to that of FIG. 3, the first rotation axis 5 rotates 360 degrees, resulting in the cutting tool 7 rotating 360+Db degrees. For this reason, the NC machining tool 100 rotates the first rotation axis 5 by 360 minus Db degrees, thereby causing the cutting tool 7 to rotate 360 degrees and the state to transfer from FIG. 2 to FIG. 4. The generation of Db accompanies the movement of the virtual axis X, and Db is generated according to an amount of movement of the virtual axis X during transfer of the state from FIG. 2 to FIG. 3 (FIG. 4); thus, the rotation angle of the first rotation axis 5 is corrected accordingly.

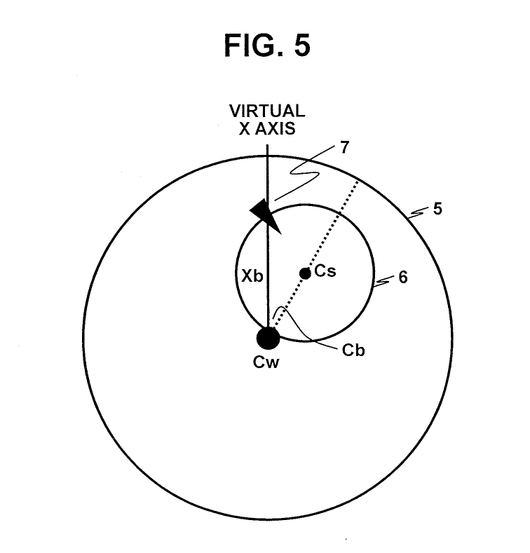

When the state of FIG. 2 transfers to that of FIG. 4, the cutting tool 7 is oriented in an unintended direction, as shown in FIG. 5. This problem is, thus, handled in the target NC machining tool 100 to be controlled, thereby causing the cutting tool 7 to always point the center of the first rotation axis 5.

The series of control operations is executed in an analogous fashion while the first rotation axis 5 is rotated as the main axis. Specifically, in the series of control operations, FdT of the first rotation axis 5 corresponds to FdT at a rotation speed in situations where the first rotation axis 5 is commanded to rotate as the main axis, and to FdT due to correction of the position of the cutting tool 7 that accompanies the movement of the virtual axis X.

FdTs of the first and the second rotation axes calculated as described previously at the movement assignment unit 54, and FdTs of the other axes calculated at the interpolation unit 52, are transmitted by the servo signal processing unit 15 to the first, second and third drive units 1, 2 and 3.

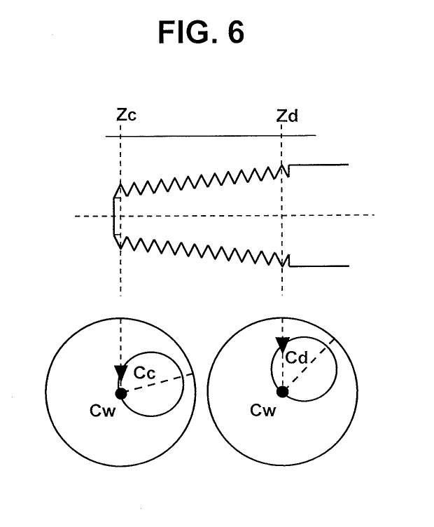

FIG. 6 is a diagram illustrating a situation where taper-threading is made by the series of control operations. In the conventional screw threading, constant pitch threads can be made by the main axis rotating one turn during a time when the axis moving in the longitudinal direction of a workpiece 12 moves by a commanded amount with regard to a thread pitch.

In the NC machining tool 100, constant pitch threads can be made by the fact that the position of the cutting tool 7 relative to the first rotation axis 5 rotates one turn during a time when the axis moving in the longitudinal direction of the workpiece 12 moves by a commanded amount with regard to a thread pitch; thus, the taper threading causes an amount of correction for the first rotation axis 5 to vary in synchronization with the longitudinal movement in the workpiece 12.

Referring to FIG. 6, an amount of correction Cc for the first rotation axis 5 corresponds to a longitudinal position Zc of a workpiece, while an amount of correction Cd therefor corresponds to a longitudinal position Zd of the workpiece. Because the amount of correction for the first rotation axis 5 is calculated by the interpolation unit 52 every time the virtual axis X varies its position, the correction amount varies in synchronization with the movement of the tool in the longitudinal direction of the workpiece 12 calculated by the interpolation unit 52.

The NC apparatus 50 and NC machining system according to the present invention is suitable for use as an apparatus for controlling machining tools intended for machining a workpiece—such as having a large machining radius, a large length, or partially cylindrical or tapered shape—in a cylindrical or taper shape, without rotating the workpiece.

### INDUSTRIAL APPLICABILITY

The present invention is applicable to numerical controllers (NC apparatuses) and numerical machining systems.

What is claimed is:

1. A numerical control machining system, comprising:
a chuck that clamps a workpiece;
a first rotation axis, located opposite the chuck, that rotates as a main axis;
a second rotation axis that rotates about its center on the first rotation axis;
a numerical control apparatus that outputs, according to pre-programmed machining instructions, rotation commands for the first and the second rotation axes; and
a tool, fixed on the second rotation axis, that moves along a circumferential surface of the workpiece by a rotation of the first rotation axis, and whose machining radius is determined by a rotation of the second rotation axis.

2. The numerical control machining system of claim 1, wherein the NC apparatus outputs, according to the pre-programmed machining instructions, rotation commands for the first and the second rotation axes so that the tool moves on a virtual axis that is a straight line connecting the tool position with the center of the first rotation axis.

3. The numerical control machining system of claim 1, wherein the NC apparatus outputs, according to the pre-programmed machining instructions, a move command that causes the tool to move in a direction of a straight line connecting the workpiece and the chuck.

4. The numerical control machining system of claim 2, wherein the numerical control apparatus comprises
a program analysis unit that analytically examines the pre-programmed machining instructions on a block basis and analyzes an amount of movement of the virtual axis in a single block;
an interpolation unit that calculates, based on results of analysis made by the program analysis unit, the amount of movement of the virtual axis, to be produced at intervals of an interpolation period; and
a movement assignment unit that converts the amount of movement of the virtual axis, calculated by the interpolation unit, into an amount of movement of a rotation angle of each of the first and the second rotation axes.

5. A numerical control apparatus, the apparatus configured to output:
a rotation command that instructs a first rotation axis to moves along a circumferential surface of a workpiece; and
a rotation command that instructs a second rotation axis to determine a machining radius of a tool, according to pre-programmed machining instructions for the first rotation axis, located opposite a chuck for clamping the workpiece, that rotates as a main axis, and for the second rotation axis on which the tool is fixed and that rotates about its center on the first rotation axis.

6. The numerical control apparatus of claim 5, wherein the apparatus outputs, according to the pre-programmed machining instructions, rotation commands for the first and the second rotation axes so that the tool moves on a virtual axis that is a straight line connecting a predetermined position of the tool and the center of the first rotation axis.

7. The numerical control apparatus of claim 5, wherein the apparatus outputs a move command that moves, according to the pre-programmed machining instructions, the tool in a direction of a straight line connecting the workpiece and the chuck.

8. The numerical control apparatus of claim 6, where the apparatus comprises
a program analysis unit that analytically examines the pre-programmed machining instructions on a block basis and analyzes an amount of movement of the virtual axis in a single block;
an interpolation unit that calculates, based on results of analysis made by the program analysis unit, an amount of movement of the virtual axis, to be produced at intervals of an interpolation period; and
a movement assignment unit that converts the amount of movement of the virtual axis calculated by the interpolation unit into an amount of movement of a rotation angle of each of the first and the second rotation axes.
